(19) United States
(12) Patent Application Publication
(10) Pub. No.: US 2014/0340427 A1
(43) Pub. Date: Nov. 20, 2014

(54) METHOD, DEVICE, AND SYSTEM FOR COMPUTING A SPHERICAL PROJECTION IMAGE BASED ON TWO-DIMENSIONAL IMAGES

(71) Applicant: Logos Technologies LLC, Fairfax, VA (US)

(72) Inventor: Patrick Terry Baker, Washington, DC (US)

(21) Appl. No.: 14/366,405

(22) PCT Filed: Jan. 17, 2013
(86) PCT No.: PCT/US2013/021924

§ 371 Date: Jun. 18, 2014

Related U.S. Application Data
(60) Provisional application No. 61/632,069, filed on Jan. 18, 2012.

(51) Int. Cl. G06T 5/50; G06T 3/00

(52) U.S. Cl. CPC G06T 5/50; G06T 3/0068; G06T 2207/20221; G06T 2215/08
USPC 345/641

(57) ABSTRACT

An image projection method for generating a panoramic image, the method including the steps of accessing images that were captured by a camera located at a source location, and each of the images being captured from a different angle of view, the source location being variable as a function of time, calibrating the images collectively to create a camera model that encodes orientation, optical distortion, and variable defects of the camera; matching overlapping areas of the images to generate calibrated image data, accessing a three-dimensional map, first projecting pixel coordinates of the calibrated image data into a three-dimensional space using the three-dimensional map to generate three-dimensional pixel data, and second projecting the three-dimensional pixel data to an azimuth-elevation coordinate system that is referenced from a fixed virtual to generate the panoramic image.

### FIELD OF THE INVENTION

The present invention relates generally to methods, devices, and systems for computing a projection image based on a spherical coordinate system by using two-dimensional images that were taken with different centers of projection.

### BACKGROUND OF THE INVENTION

In imaging surveillance systems, for example for persistent surveillance systems, usually high resolution images are generated from a scenery by a camera system that can capture images from different viewing angles and centers of projection. These individual images can be merged together to form a high-resolution image of the scenery, for example a two or three-dimensional orthographic map image. However, when such a high-resolution image is generated that is projected to an orthographic coordinate system, portions of the image far from the center of projection compared to an altitude of the capturing sensor will be presented with very poor (anisotropic) resolution due to the obliquity. In addition, because a location of the source is often constantly moving, the image will have parallax motion which degrades a visual and algorithmic performance. Accordingly, in light of these deficiencies of the background art, improvements in generating high-resolution projection images of a scenery are desired.

### SUMMARY OF THE EMBODIMENTS OF THE INVENTION

According to one aspect of the present invention, an image projection method for generating a panoramic image is provided, the method performed on a computer having a first and a second memory. Preferably, the method includes a step of accessing a plurality of images from the first memory, each of the plurality of images being captured by a camera located a source location, and each of the plurality of images being captured from a different angle of view, the source location being variable as a function of time, and calibrating the plurality of images collectively to create a camera model that encodes orientation, optical distortion, and variable defects of the camera. Moreover, the method further preferably includes the steps of matching overlapping areas of the plurality of images to generate calibrated image data having improved knowledge on the orientation and source location of the camera, accessing a three-dimensional map from the second memory, and first projecting pixel coordinates of the calibrated image data into a three-dimensional space using the three-dimensional map to generate three-dimensional pixel data. Moreover, the method further preferably includes a step of second projecting the three-dimensional pixel data to an azimuth-elevation coordinate system that is referenced from a fixed virtual viewpoint to generate transformed image data and using the transformed image data to generate the panoramic image.

Moreover, according to another aspect of the present invention, a non-transitory computer readable medium having computer instructions recorded thereon is provided, the computer instructions configured to perform an image processing method when executed on a computer having a first and a second memory. Preferably, the method includes a step of accessing a plurality of images from the first memory, each of the plurality of images being captured by a camera located a source location, and each of the plurality of images being captured from a different angle of view, the source location being variable as a function of time, and calibrating the plurality of images collectively to create a camera model that encodes orientation, optical distortion, and variable defects of the camera. Moreover, the method further preferably includes the steps of matching overlapping areas of the plurality of images to generate calibrated image data having improved knowledge on the orientation and source location of the camera, accessing a three-dimensional map from the second memory, and first projecting pixel coordinates of the calibrated image data into a three-dimensional space using the three-dimensional map to generate three-dimensional pixel data. Moreover, the method further preferably includes a step of second projecting the three-dimensional pixel data to an azimuth-elevation coordinate system that is referenced from a fixed virtual viewpoint to generate transformed image data and using the transformed image data to generate the panoramic image.

In addition, according to yet another aspect of the present invention, a computer system for generating a panoramic image is provided. The computer system preferably includes a first memory having a plurality of two-dimensional images stored thereon, each of the plurality of images captured from a scenery by a camera located a source location, and each of the plurality of images being captured from a different angle of view, the source location being variable as a function of time, a second memory having a three-dimensional map from the scenery; and a hardware processor. Moreover, the hardware processor is preferably configured to calibrate the plurality of images collectively to create a camera model that encodes orientation, optical distortion, and variable defects of the camera, and to match overlapping areas of the plurality of images to generate calibrated image data having improved knowledge on the orientation and source location of the camera. In addition, the hardware processor is further preferably configured to first project pixel coordinates of the calibrated image data into a three-dimensional space using the three-dimensional map to generate three-dimensional pixel data, and to second project the three-dimensional pixel data to an azimuth-elevation coordinate system that is referenced from a fixed virtual viewpoint to generate transformed image data and using the transformed image data to generate the panoramic image.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a diagrammatic view of a method according to one aspect of the present invention;

FIG. 2 is a diagrammatic perspective view of an imaging system capturing images from a scenery when performing the method of FIG. 1;

FIG. 3 is a schematic view of a spherical coordinate system that is used for projecting the captured images; and

FIG. 4 is a schematic view of a system for implementing the method shown in FIG. 1.

Herein, identical reference numerals are used, where possible, to designate identical elements that are common to the figures. Also, the images in the drawings are simplified or illustration purposes and may not be depicted to scale.

### DETAILED DESCRIPTION OF THE PREFERRED EMBODIMENTS

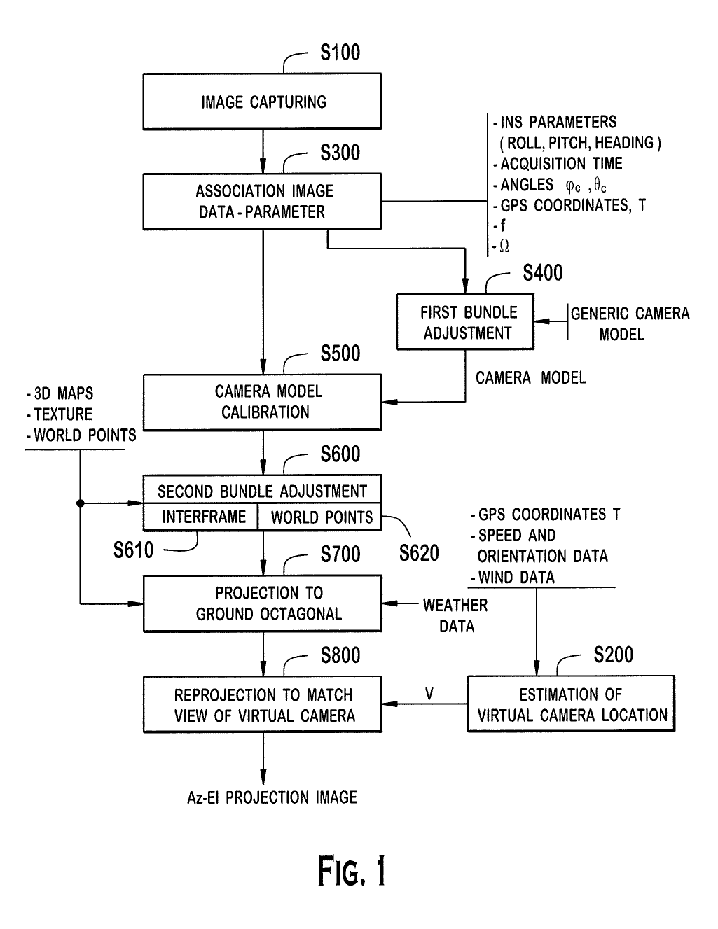

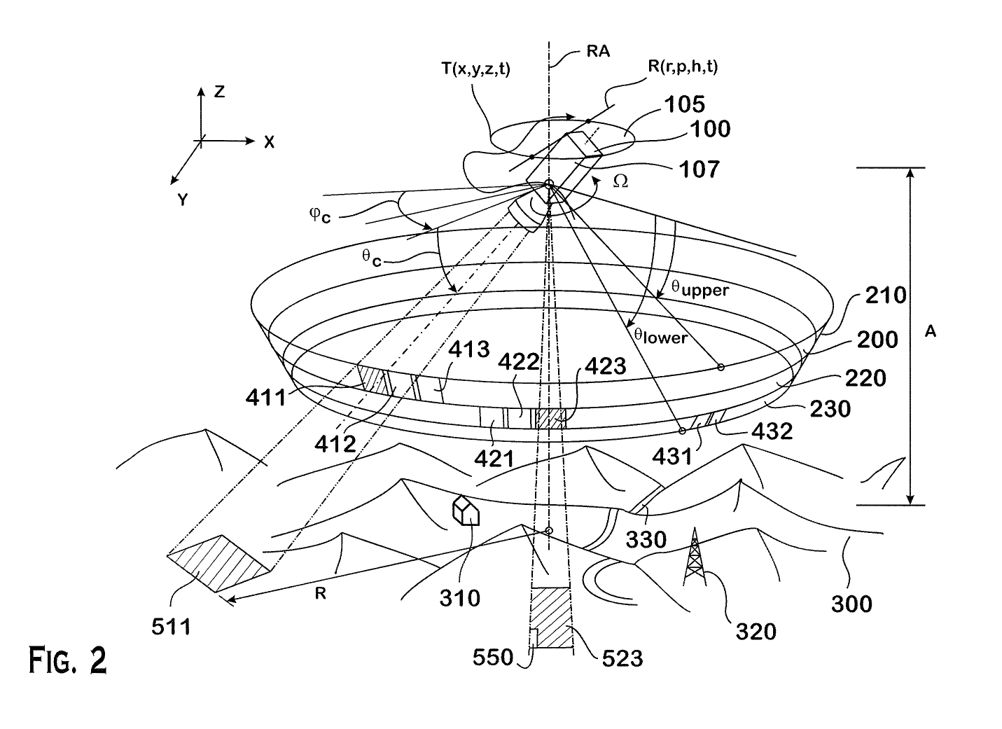

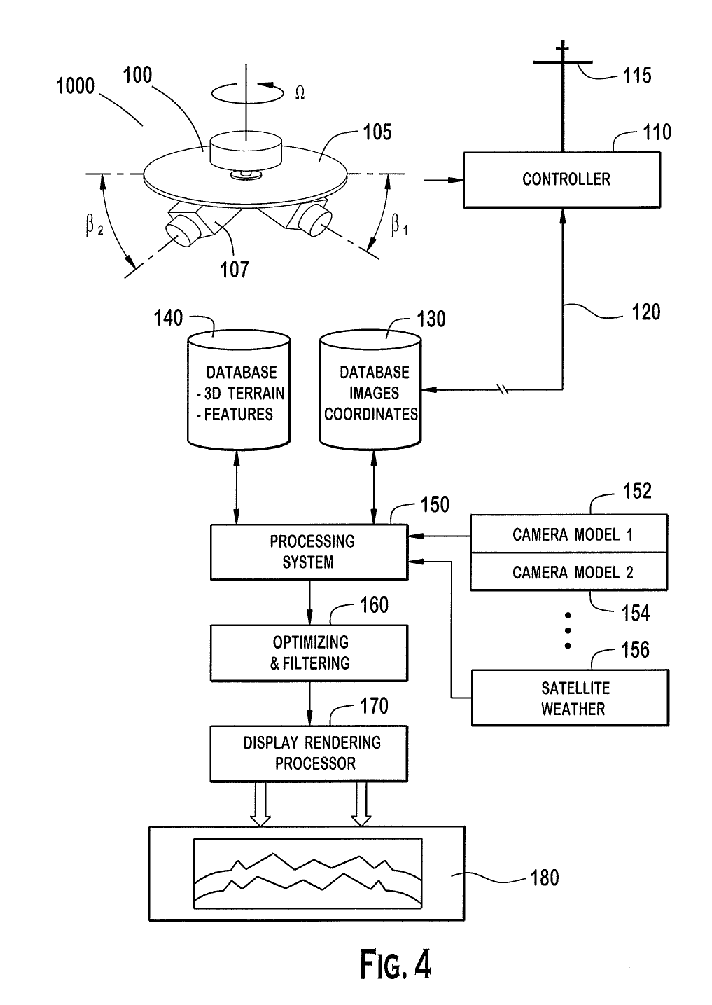

FIG. 1 depicts diagrammatically a method of generating panoramic images according to a first embodiment of the present invention, with FIG. 2 depicting a scenery 300 that is viewed by a camera 107 of camera unit 100 of an imaging system 1000 (FIG. 4) for performing the method of FIG. 1. As shown schematically in FIG. 2, two-dimensional (2D) images 411-413, 421-423, and 431-433 of a scene 200 are captured and stored by imaging system 1000 by using camera unit 100 that captures images 411-413, 421-423, and 431-433 from camera location T. Camera unit 100 may be composed of a plurality of cameras 107 that may rotate or may be stationary, for example as shown in FIG. 2 a camera 107 that is rotating with a rotational velocity Ω by use of rotational platform 105 installed as a payload on an aerostat such as but not limited to a blimp, a balloon, or aerodynes such as but not limited to flight drones, helicopters, or other manned or unmanned aerial vehicles (not shown). In addition to rotational velocity Ω being the azimuthal rotation, there is another rotation R of the inertial navigation system (INS) that parameterizes the overall orientation of imaging system 1000, including the parameters roll r, pitch p, and heading or yaw h (not shown). R(t)=[r, p, h] can specify the current orientation of imaging system 1000 in the same way as location T(t)=[x, y , z] specifies the position. It is also possible that multiple images are captured simultaneously from multiple cameras 107 circularly arranged around location T with different angles of view all pointing away from location T. The actual geographic position of camera unit 100 will usually not be stationary, but will follow a trajectory [x,y,z]=T(t) that varies over time. This is due to the fact that the aerial vehicle carries camera unit 100 cannot be perfectly geostationary and will move due to wind gusts, thermal winds, or by the own transversal movement of the aerial vehicle. Also, rotational velocity Ω of camera unit 100 may be influenced by INS rotation R of the imaging system 1000.

Typically, 2D images 411-413, 421-423, and 431-433 that compose a scene 200 are captured during one scanning rotation by camera unit 100. For example, if camera unit 100 rotates at Ω=1 Hz, one camera 107 is used, and the image capturing frequency is f=100 Hz, then 100 images 411-413 will be captured for a scene 210. In case multiple parallel operated cameras 107 are viewing the entire scene 200, 2D images 411-413, 421-423, and 431-433 are captured at one capturing event at the same time. Also, it is not necessary that scene 200 covers a full rotation of 360°, and it is also possible that scene 200 is only composed of one or more sectors that are defined by azimuthal angles φ.

Captured 2D images 411-413, 421-423, and 431-433 picture portions of a panoramic scene 200, the size of scene 200 being defined by the elevation view angles of the camera unit 100. Scene 200 may be defined by upper and lower elevation angles θᵤₚₚₑᵣ, θ_{lower} of the scene 200 itself, and these angles will depend on the elevation angles of cameras 107 and the field of view of the associated optics. Preferably, upper elevation angle θᵤₚₚₑᵣ is in a range between −10° and 30°, the negative angle indicating an angle that is above the horizon that is assumed at 0°, and lower elevation angle θ_{lower} is in a range between 40° and 75°. In the variant shown in FIG. 1, the angle range is approximately from 20° to 60°.

Also, adjacent images, for example 411 and 412, are preferably overlapping. By using additional cameras in camera unit 100 having a different elevation angle θ_{c} as compared to the first camera, or by changing an elevation angle θ_{c} of a sole camera that is rotating with rotational velocity Ω, it is possible to capture one or more additional panoramic scenes 210, 220, 230 that will compose the viewed panoramic scene 200 with images 411-413 (upper panoramic scene 210), images 421-423 (middle panoramic scene 220), and images 431-433 (lower panoramic scene 230) associated thereto. While images 411-413, 421-423, and 431-433 are represented in FIG. 2 in an imaginary sphere represented as scene 200 with partial panoramic scenes 210, 220, 230 so as to show them references to an azimuth-elevation spherical coordinate system, they are actually viewing a corresponding surface of scenery 300. For example, image 411 is representing a viewed surface 511 of scenery 300, while image 423 is representing a viewed surface 523.

Preferably, the sequentially captured images of a respective panoramic scene 210, 220, 230 are overlapping, for so that a part of image 411 will overlap the next captured image 412, and image 412 overlaps partially with next captured image 413, etc. However, this is not necessary, it is also possible that images 411-413 are taken with rotational velocity Ω, image capturing frequency f, and camera viewing angles that do not produce overlapping images, but that images captured from a first rotation of camera unit 100 to capture images from panoramic scene 210 overlap with images captured from a subsequent rotation of camera unit 100 in imaging system 1000 of the panoramic scene 210.

Moreover, preferably camera unit 100 is arranged such that the adjacent panoramic scenes 210, 220, 230 overlap with an upper or lower neighboring panoramic scene in a vertical direction, for example, upper panoramic scene 210 overlaps with middle panoramic scene 220, and lower panoramic scene 230 overlaps with middle panoramic scene 220. Thereby, in a subsequent process, it is possible to stitch images 411-413, 421-423, and 431-433 together to form a segmented panoramic image having a higher resolution of the viewed scenery. Preferably, images are captured along a full rotation of 360° by rotation of camera system 100 with rotational speed Ω or from a plurality of cameras with different viewing angles, but it is also possible that images are merely captured from a sector or a plurality of sectors without capturing image along a portion of the 360° view of the panoramic scene.

Moreover, camera unit 100 also captures images from scenery 300 that may have objects or world points 310, 320, 330, that are geostationary and are located on scenery so as to be viewable by camera unit 100, such as buildings 310, antennas 320, roads 330, etc., and these world points 310, 320, 330 can be either recognized by feature detection and extraction algorithms from captured images 411-413, 421-423, and 431-433, or can simply be manually located within the images by having access to coordinate information of these world points 310, 320, 330. Also, imaging system 1000 can dispose of a topographical map of the part of scenery 300 that is within viewable reach of camera unit 100, for example a three-dimensional (3D) map that is preferably based on a orthographic coordinate system.

Generally, while images 411-413, 421-423, and 431-433 in an azimuth/elevation (Az-El) coordinate system represent a natural view of the viewed surfaces of scenery 300 by camera unit 100 having pixels representing a substantial similar view angle, if the same images would be viewed in the orthographic coordinate system to represent surfaces 511 and 523 of scenery 300, these images would represent surfaces 511 and 523 in a very distorted way, with an decreased resolution with an increasing radial distance R from a rotational axis RA of camera unit 100. For oblique angles, it is often more appropriate to view the image data from the perspective of the image capturing camera 107, or in close proximity thereof, in particular when data from other cameras 107 will be used to compare the image data. In such a case, the Az-El coordinate system for projection presents a more natural solution to view the image data. In addition, the use of an Az-El coordinate system will also make the images appear more natural and is more efficient for image processing. The projection to a fixed azimuth/elevation camera location is an important aspect of the present invention which allows to generate stable imagery and to make subsequent processing easier.

For example, assuming the altitude A of camera unit 100 is 2 km, and a radial distance R of viewed surface 523 is 15 km, every pixel of image 411 will represent a narrow strip 550 of surface 523 that is extended in radial direction away from rotational axis RA. This distorted projection is the result of an affine transformation of the pixel response function. Generally, projection result being a narrow strip 550 has a trapezoidal shape, but the angles are in the order of 10⁻⁴ rad. This distortion can be neglected especially in contrast to the distortion from the foreshortening that can be a factor of 100, tan⁻¹5°. Therefore, when viewed in the orthographic coordinate system, images 411-413, 421-423, and 431-433 of the scenery 300 would appear very distorted at distances that are far from a center projection of camera unit 100 compared to its altitude. In addition, because the location of camera unit 100 is not constant, images that appear directly under camera unit 100 in direction of the rotational axis RA and a certain angular range will have a parallax errors, and artifacts may occur as a result of differences in time of capture between images 411-413, 421-423, and 431-433.

Therefore, the present invention aims to represent images 411-413, 421-423, and 431-433 in a spherical Az-El coordinate system, to provide a more natural viewing projection for the user, and to avoid the generation of strongly distorted images for scenery portions that are located for from camera unit 100 that would be of little use for a human user or image processing software for object recognition and tracking. In addition, another goal of the present invention is to project the captured image data from a fixed virtual camera source location V=[x_v, y_v, z_v] that is geostationary, despite the movements of camera unit 100 by trajectory [x_t, y_t, z_t]=T(t). This way, issues of parallax and other image distortions can be at least partially eliminated. This projection from the virtual camera source also substantially eliminates the effects of motion of camera unit 100 for an image sequence, so that the compressibility of the image sequence is improved, and also the performance of tracking and change detection algorithms are improved.

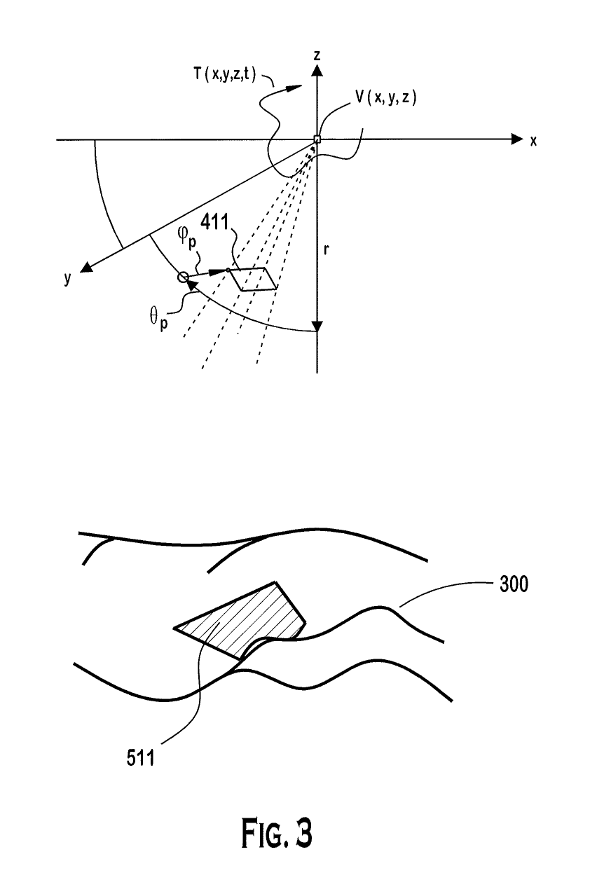

Next, data from the step S100 of capturing images with camera unit 100, images 411-413, 421-423, and 431-433 are associated to metadata with information on time of capture, location of capture, and geometrical arrangement of camera at time of capture, in a step S300. For example by associating the trajectory position T, elevation angle θ_{c}, and azimuth angle φ_{c}, and rotational speed Ω, INS rotation R, camera lens information, at time of the image capture, to the respective image. FIG. 3 depicts the geometry of an Az-El coordinate system depicting azimuth angle φ_{c} and elevation angle θ_{c} of a spherical coordinate system that characterizes the viewing angle of camera system 100 at time of image capture. In this step S300, the image data is stored together with an association to the relevant metadata. This step can be performed with a processing unit that is located at the camera unit 100. Every captured 2D image 411-413, 421-423, and 431-433 is also associated with the location T where in space the images were taken, and a series of such locations can be expressed as a trajectory [x_t, y_t, z_t]=T(t) that is variable in time.

In an additional step S200, the virtual camera source location V=[x_v, y_v, z_v] can be determined by an algorithm, for example by determining a location V that is in close proximity of a real camera location T, for example by using estimation techniques to predict a location V that will be close to present location T based on data of the past trajectory [x_t, y_t, z_t]=T(t). In addition, it is also possible to use a location V that is somewhat different than the location T, based on the user's viewing preference, for example by using a virtual camera source location V that is independent of the actual trajectory. The virtual camera source location V need not be a permanently fixed location, but can be refreshed at regular intervals, or for example when location T is outside a certain geographic range, preferably once camera unit 100 moves more than 10% of the distance to the ground. This allows to take global movements of camera unit 100 into account, for example if there is a dominant transversal movement when camera unit 100 is carried by a flying drone, or winds are pushing an aerostat in a certain direction.

As an example, virtual camera source location V=[x_v, y_v, z_v] can be determined by using the immediately past trajectory [x_t, y_t, z_t]=T(t) during a certain time period, for example a period of the past 10 seconds, and then generate a median or mean value of all the samples of trajectory T that will serve as location V. Data for trajectory T can be generated by using a satellite receiver 115 of the Global Positioning System (GPS) that is located at the same place as the camera unit 100. This calculated location V can be refreshed at periodic interval that is different from the time period that is used for gathering passed data on trajectory T. Such way of calculating the virtual camera source location V=[x_v, y_v, z_v] is especially useful is a location of imaging system 1000 is substantially stationary and is not subject to any predictable transversal movement, such as it would be the case if a balloon or a blimp is used to carry imaging system 1000.

In case camera unit 100 is performing a substantially transversal movement, for example when camera unit 100 is part of a payload that is installed on an aircraft moving at a certain speed over viewed scenery, the virtual camera source location V=[x_v, y_v, z_v] can be predicted for periods of time, for example by calculating an average motion vector of trajectory T for past periods, to gather period information on how much the camera unit 100 will move during a certain time period. This information can be further completed by having access to the speed of the aircraft, and speeds and directions of winds. Next based on this information, a virtual camera source location V for a next time period can be predicted that would correspond to a mean or median location if camera unit 100 would continue to move at the same average motion. It is also possible to estimate a virtual camera source location V=[x_v, y_v, z_v] by using maximum-likelihood estimation techniques, based on data on past camera source location T, present and past wind data, and flight speed of aircraft carrying camera unit 100.

Next, based on data of images 411-413, 421-423, and 431-433, a first bundle adjustment is performed in step S400 that results in a camera model 152 for calibrating image data for all cameras 107 of the camera unit 100. This is a calibration step that calibrates all the cameras together to form a unified camera model 152 that can take into account all internal camera parameters such as pixel response curves, fixed pattern noise, pixel integration time, focal length, aspect ratio, radial distortion, optic axis direction, and other image distortion. For this purpose, a processor performing step S400 also disposes of a generic camera models of the camera 107 that was used from camera unit 100 to capture the respective image. Preferably, the generic camera models have a basic calibration capacity that is specific to the camera 107 and lens used, but has parameters that can be adjusted depending on variances of camera 107, image sensor, lenses, mirrors, etc.

Preferably, the first bundle adjustment is done only once before operating the imaging system 1000, but can also be repeated to update camera model 152 after a predetermined period of time, or after a certain trigger event, for example after camera unit 100 was subject to a mechanical shock that exceeded a certain threshold value. Therefore, the adaptation of the existing camera model 152 by a step S400 allows to take variable defects into account, for example certain optical aberrations that are due to special temperature, mechanical deformation effects of scanning mirrors and lenses used, and other operational conditions of camera unit 100. The camera model 152 generated by step S400 are represented as a list of parameters which parameterize the nonlinear mapping from three-dimensional points in the scenery to two-dimensional points in an image.

Based on camera model 152, every image that is later captured by camera unit 100 will be calibrated by a step S500 to generate calibrated image data based on the camera model 152 for camera 107 that captured the image. The camera model calibration step S500 takes into account optical distortions of the lenses of the cameras, image sensor distortions, so that for every pixel of each image 411-413, 421-423, and 431-433 a camera-centered azimuth and elevation angle can be established. This also allows to establish the viewing angles between the pixels of images 411-413, 421-423, and 431-433, for each pixel. Therefore, the first bundle adjustment generates a data set of directional information for each pixel on real elevation angle θ_{c}, azimuth angle φ_{c}, and the angular difference between neighbouring pixels. This camera model calibration step S500 does not take into account any dynamic effects of imaging system due to rotation Ω, INS rotation R, movement of location by trajectory T, and other distortions that are not internal to the capturing camera.

Next, the images that were processed by camera model calibration step S500 are subject to a processing with a second bundle adjustment step S600, that includes an interframe comparison step S610 that attempt to match overlapping parts of adjacent images, and a world point matching step S620 where overlapping parts of adjacent images are matched to each other or to features or world points 310, 320, 330 of scenery 300. The second bundle adjustment step S600 allows to estimate with higher precision where the individual pixels of cameras 107 of camera unit 100 are directed to. Due to the motion of trajectory T of camera unit 100, consecutively captured images are rarely captured from exactly the same location, and therefore the second bundle adjustment step S600 can gather more information of the displacement and orientation of the imaging system 1000. Thereby, it is possible to refine the directional information of each pixel, including relative elevation angle θ_{c}, azimuth angle φ_{c}, and the angular difference between neighbouring pixels, based on image information from two overlapping images.

In the interframe processing step S610 on the overlapping parts of adjacent images 411 and 412, image registration is performed where matching features in the overlapping part between two images 411 and 412 are searched for, for example by searching for image alignments that minimize the sum of absolute differences between the overlapping pixels or calculate these offsets using phase correlation. This processing allows to create data on corresponding image information of two different images that overlap, to further refine the pixel information and the viewing angle of the particular pixels. Also, interframe processing step S610 can apply corrections to colors and intensity of the pixels to improve visual appearance of the images, for example by adjusting colors of mapping pixels and changing pixel intensity of exposure differences. Interframe processing step S610 can prepare the images for later projection processing to make the final projected images more appealing to a human user.

Moreover, in the world points matching step S620, based directional information in which direction the camera of camera unit 100 that captured respective image is pointing, pre-stored world points 510, 520, 530 can be located in overlapping part of images 411, 412, so that a matching feature can be matched in order to improve the knowledge of orientation and position. This is particularly useful if it is desired to maintain geoaccuracy by matching to imagery with known geolocation. In this processing step, it is also possible to further match the non-overlapping part of images with certain world points 510, 520, 530, to further refine the directional information. This step can access geographic location data and three-dimensioning modeling data of world points, so that an idealized view of the world points 510, 520, 530 can be generated from a virtual view point. Because the location of camera unit 100 at time of image capture and the location of world points 510, 520, 530 is precisely known, a projected view onto world points 510, 520, 530 can be compared with captured image data from a location T, so that additional data is available to refine the directional information that is associated with pixel data of images 411-413, 421-423, and 431-433.

As explained above, the geographic location of the world points 510, 520, 530 is usually stored in a database in the orthographic coordinate system references to a 3D map, but a coordinate transformation can be performed on data of world points in step S620 to generate Az-El coordinates that match the elevation angle θ_{c}, and azimuth angle φ_{c}, of the captured image, so that the world points 510, 520, 530 can be located on overlapping or non-overlapping parts of images 411-413, 421-423, and 431-433. However, it is also possible that world points are newly generated without receiving such data from an external mapping database, for example by performing a feature or object detection algorithm on overlapping parts of adjacent images 411 and 412, so that overlapping parts of an image can be better matched. Such object detection algorithm can thereby generate new world points that appear conspicuously on the images 411, 412 for matching. Accordingly, the results of both the interframe processing step S610 and the world points matching step S620 will further calibrate the images to an Az-El coordinate system.

Next, the image data that was subject to the second bundle adjustment in step S600 is then projected to an existing 3D map in step S700. Preferably, this step requires that coordinate data of the scenery 300 is available as 3D coordinate mapping data, for example in the orthographic or Cartesian coordinate system that is accessed from a database. In a variant, if the landscape of scenery 300 is very flat, for example a flat desert or in maritime applications, it may be sufficient to project the image data to a flat surface for which the elevation is known, or a curved surface that corresponds to the Earth's curvature, without the use of a topographical 3D map. With this projection in step S700, the pixel data is projected by using associated coordinates on elevation angle θ_{c}, and azimuth angle φ_{c}, and camera source capture location T for each pixel towards but a 3D topographical map or a plane in the orthographic coordinate system, so that each pixel is associated with an existing geographic position in x, y, and z coordinate system on the map. Based on this projection, ground coordinates for the image data referenced to the orthographic coordinate system is generated. Step S700 is optional, and in variant it is possible to pass directly from the second bundle adjustment step S600 to a projection step S800 that generates a panoramic image based on a spherical coordinate system, as further described below.

The thus generated image data and is associated ground coordinates can be further processed based on stored data of the topographical map, so as to adjust certain pixel information and objects that are located in the ground image. For example, the image data can be processed to complement the image data content with data that is available from the 3D maps, for example color patterns and textures of the natural environment and buildings such as roads, houses, as well as shadings, etc. can be added. In addition, if three dimensional weather data is available, for example 3D data on clouds that intercept a viewing angle of camera unit 100, this information could be used to mark corresponding pixels as not being projectable to the 3D topographical map.

In addition, in a variant, it is also possible that 3D on weather patterns are available from a data link or database for projection step S700, for example geographic information on location of clouds or fog. The projection step S700 would thereby be able to determine whether a particular view direction from location [x_t, y_t, z_t]=T(t) is obstructed by clouds and fog. If the processing step confirms that this is the case, it would be possible to either replace or complement pixel data that are located in those obstructed view directions with corresponding data that is available from the topographical 3D map to complete the real view with artificial image data, or to mark the obstructed pixels of the image with a special pattern, color, or label, so that a viewer is readily aware that these parts of the images are obstructed by clouds or fog. This is advantageous if the image quality is low, for example in low lighting conditions, or homogenous scenes in a desert, ocean, etc.

Because the ground coordinates of the image data associates pixel data to an orthographic coordinate systems, this data could theoretically be displayed as a map on a screen and viewed by a user. But as explained above, pixel information on map portions that are located far away from the camera location will appear as a narrow strip 550 to the viewer. In addition, the orthographic coordinate system does not take into account movements of camera source location T, and many artifacts would be present due to parallax for image that point downwards along the rotational axis RA. Such orthographic ground image would therefore be of poor quality for a human user for viewing scenery 300. In addition, depending on the lower elevation angle θ_{lower} of scene 200, there may be no image data available for parts of the scenery 300 that are located under the camera unit 300 around the rotational axis RA.

Accordingly, the thus generated ground image that is based on ground coordinates and image data is subject to a reprojection step S800 that generates a panoramic image based on a spherical coordinate system with coordinates having elevation angle θₚ and azimuth angle φₚ that are again associated to each pixel as shown in FIG. 3, but as seen from a virtual camera source location V=[x_v, y_v, z_v]. As explained above, the virtual camera source location V can be fixed, estimated, calculated, and can be periodically updated, but will have at least for a certain period a fixed geographic position, as discussed with respect to step S200. The pixels of the reprojected image that will be composed from many 2D images will therefore be references in the Az-El coordinate system, as an Az-El panoramic image, from a fixed virtual viewpoint.

Because imaging system 1000 is configured to view a segment or a full circle of a panoramic scene 200 that is define by an upper and a lower elevation angle θᵤₚₚₑᵣ, θ_{lower}, this form of projection of the data corresponds more naturally to the originally captured data, but the initially captured 2D image data from images 411-413, 421-423, 431-433 has been enhanced by data and information from the pre-existing 3D map, world points 510, 520, 530, geometric calibration, and have been corrected to appear as if the images were taken from a fixed location V. Such Az-El panoramic image is also more suitable for persistent surveillance operations, where a human operator has to use the projected image to detect events, track cars that are driving on roads, etc. This coordinate transformation that was performed in step S800 is used to warp the image data for projection and display purposes to from the image to the Az-El coordinate system.

As described above with reference to FIG. 1, the steps of the image projection method appear in a certain order. However, it is not necessary that all the processing steps are performed in the above described order. For example, the intra-frame world point matching step S610 need to be a sub-step of the second bundle adjustment step S600, but may be performed as a separate step before the matching of the world points 5620.

FIG. 4 shows an exemplary imaging system 1000 to perform the method described above with respect to FIG. 1. Imaging system 1000 includes a camera unit 100 with one or more cameras 107 that may either rotate at a rotational speed Ω to continuously capture images, or be composed of cameras that are circularly arranged around position T to capture image from different view angles simultaneously to capture overlapping images of panoramic scene 200. In a variant, camera unit 100 or individual cameras 107 of the camera unit 100 are not rotated, by a rotating scanning mirror (not shown) is used for the rotation, or a plurality of cameras 107 are used that are circularly arranged around location T and optically configured to substantially cover either panoramic scene 200, or a sector thereof. In a variant, three pairs of cameras 107 are rotating, each pair of cameras being composed of a 1024 to 1024 pixel visible light charge-coupled device (CCD) image sensor camera, and a focal plane array (FPA) thermal image camera, and each pair having a different elevation angles (β₁, β₂ and β₃ so that visible light images and thermal images are captured simultaneously captured from the same partial panoramic scene 210, 220, and 230.

A controller 110 controls the capturing of the 2D images, but also captures simultaneously data that is associated to conditions of each captured image, for example a precise time of capture, GPS coordinates of the location of camera unit 100 at time of capture, elevation angle θ_{c} and azimuth angle φ_{c} of the camera at time of capture, weather data including temperature, humidity and visibility. Elevation angle θc and azimuth angle cpₛ can be determined from positional encoders from motors rotating camera unit or scanning mirrors that is accessible by controller 110, and based on GPS coordinates and orientation of an aircraft carrying the camera unit 100. Moreover, controller 110 is configured to associate these image capturing conditions as metadata to the captured 2D image data. For this purpose, the controller 110 has access to a GPS antenna and receiver 115. 2D image data and the associated metadata can be sent via a data link 120 to a memory or image database 130 for storage and further processing with central processing system 150. Data link 120 may be a high-speed wireless data communication link via a satellite or a terrestrial data networking system, but it is also possible that memory 130 is part of the imaging system 1000 and is located at the payload of the aircraft for later processing. However, it is also possible that the entire imaging system 1000 is arranged in the aircraft itself, and therefore data link 120 may only be a local data connection between controller 110 and locally arranged central processing system 150.

Moreover, in a variant, cameras 107 of camera unit 100 are each equipped with a image processing hardware, so called smart or intelligent cameras, so that certain processing steps can be performed camera-internally before sending data to central processing system 150. For example, certain fixed pattern noise calibration, the first bundle adjustment of step S400, the association of image data with certain data related to image capture of step S300 can all be performed within each camera 107, so that less processing is required in central processing system 150. For this purpose, each camera 107 would have a camera calibration model stored in its internal memory. The camera model 152 could also be updated, based on results of the second bundle adjustment step S500 that can be performed on central processing system 150. In a variant, the world point matching step S520 that matches world points to non-overlapping parts of a captured image could also be performed locally inside camera 107.

Central processing system 150 is usually located at a remote location from camera unit 100 at a mobile or stationary ground center and is equipped with image processing hardware and software, so that it is possible to process the images in real-time. For example, processing steps S500, S600 and S700 can be performed by the central processing system 150 with a parallel hardware processing architecture. Moreover, the imaging system 1000 also includes a memory or map database 140 that can pre-stores 3D topographical maps, and pixel and coordinate information of world points 510, 520, 530. Both map database 140 with map information and image database 130 with the captured images are accessible by the image processing system 150 that may include one or more hardware processors. It is also possible that parts of the map database be uploaded to individual cameras 107, if some local intra-image processing of cameras 107 requires such information.

Moreover, central processing system 150 may also have access to memory that stores camera model 152 for respective cameras 107 that are used for camera unit 100. Satellite or other type of weather data 156 may also be accessible by central processing system so that weather data can be taken into consideration for example in the projection steps S700 and S800. Central image processing system 150 can provide the Az-El panoramic image data projection that results from step S800 to an optimizing and filtering processor 160, that can apply certain color and noise filters to prepare the Az-El panoramic image data for viewing by a user. The data that results from the rendering and filtering processor 160 can then be subjected to a graphics display processor 170 to generate images that are viewable by a user on a display 180. Graphics display processor 170 can process the data of the pixels and the associated coordinate data that is based on the Az-El coordinate system to generate regular image data by warping, for regular display screen. Also, graphics display processor 170 can render the Az-El panoramic image data for display on a regular display monitor, a 3D display monitor, or a spherical or partially curved monitor for user viewing.

Moreover, the present invention also encompasses a non-transitory computer readable medium that has computer instructions recorded thereon, the non-transitory computer readable medium being at least one of CD-ROM, CD-RAM a memory card, a hard drive, FLASH memory drives, Blue Ray™ disks or any other type of portable data storage mediums. The computer instructions configured to perform an image processing method as described with reference to FIG. 1 when executed on a central processing system 150 or other suitable image processing platform. Portions or entire parts of the image processing algorithms and projection methods described herein can also be encoded in hardware on field-programmable gate arrays (FPGA), complex programmable logic devices (CPLD), dedicated digital signal processors (DSP) or other configurable hardware processors.

While the foregoing is directed to embodiments of the present invention, other and further embodiments of the invention may be devised without departing from the basic scope thereof, and the scope thereof is determined by the claims that follow.

1. An image projection method for generating a panoramic image, the method performed on a computer having a first and a second memory, comprising:
accessing a plurality of images from the first memory, each of the plurality of images being captured by a camera located at a source location, and each of the plurality of images being captured from a different angle of view, the source location being variable as a function of time;
calibrating the plurality of images collectively to create a camera model that encodes orientation, optical distortion, and variable defects of the camera;
matching overlapping areas of the plurality of images to generate calibrated image data having improved knowledge on the orientation and source location of the camera;
accessing a three-dimensional map from the second memory;
first projecting pixel coordinates of the calibrated image data into a three-dimensional space using the three-dimensional map to generate three-dimensional pixel data; and
second projecting the three-dimensional pixel data to an azimuth-elevation coordinate system that is referenced from a fixed virtual viewpoint to generate transformed image data and using the transformed image data to generate the panoramic image.

2. The image projection method of claim 1, further comprising:
estimating the fixed virtual viewpoint to be in proximity of the source location; and
periodically changing a position of the fixed virtual viewpoint.

3. The image projection method of claim 1, further comprising:
generating a displayable image by warping the transformed image data based on the azimuth-elevation coordinate system.

4. A non-transitory computer readable medium having computer instructions recorded thereon, the computer instructions configured to perform an image processing method when executed on a computer having a first and a second memory, the method comprising the steps of:
accessing a plurality of images from the first memory, each of the plurality of images being captured by a camera located at a source location, and each of the plurality of images being captured from a different angle of view, the source location being variable as a function of time;
calibrating the plurality of images collectively to create a camera model that encodes orientation, optical distortion, and variable defects of the camera;
matching overlapping areas of the plurality of images to generate calibrated image data having improved knowledge on the orientation and source location of the camera;
accessing a three-dimensional map from the second memory;
first projecting pixel coordinates of the calibrated image data into a three-dimensional space using the three-dimensional map to generate three-dimensional pixel data; and
second projecting the three-dimensional pixel data to an azimuth-elevation coordinate system that is referenced from a fixed virtual viewpoint to generate transformed image data and using the transformed image data to generate the panoramic image.

5. The non-transitory computer-readable medium according to claim 4, said method further comprising:
estimating the fixed virtual viewpoint to be in proximity of the source location; and
periodically changing a position of the fixed virtual viewpoint.

6. A computer system for generating panoramic images, comprising:
a first memory having a plurality of two-dimensional images stored thereon, each of the plurality of images captured from a scenery by a camera located a source location, and each of the plurality of images being captured from a different angle of view, the source location being variable as a function of time;
a second memory having a three-dimensional map from the scenery; and
a hardware processor configured to
calibrate the plurality of images collectively to create a camera model that encodes orientation, optical distortion, and variable defects of the camera;
match overlapping areas of the plurality of images to generate calibrated image data having improved knowledge on the orientation and source location of the camera;
first project pixel coordinates of the calibrated image data into a three-dimensional space using the three-dimensional map to generate three-dimensional pixel data; and
second project the three-dimensional pixel data to an azimuth-elevation coordinate system that is referenced from a fixed virtual viewpoint to generate transformed image data and using the transformed image data to generate the panoramic image.

7. The system according to claim 6, said hardware processor further configured to
estimate the fixed virtual viewpoint to be in proximity of the source location, and
periodically change a position of the fixed virtual viewpoint.
